(19) United States
(12) Patent Application Publication
(10) Pub. No.: US 2021/0011550 A1
(43) Pub. Date: Jan. 14, 2021

(54) MACHINE LEARNING BASED GAZE ESTIMATION WITH CONFIDENCE

(71) Applicant: Tobii AB, Danderyd (SE)

(72) Inventors: Patrik Barkman, Danderyd (SE); Anders Dahl, Danderyd (SE); Oscar Danielsson, Danderyd (SE); Tommaso Martini, Danderyd (SE); Mårten Nilsson, Danderyd (SE)

(73) Assignee: Tobii AB, Danderyd (SE)

(21) Appl. No.: 16/901,905

(22) Filed: Jun. 15, 2020

(30) Foreign Application Priority Data
Jun. 14, 2019 (SE) 1950727-6

(51) Int. Cl. G06F 3/01; G06N 20/00; G06F 17/18

(52) U.S. Cl. CPC G06F 3/013; G06F 17/18; G06N 20/00; G06F 3/017

(57) ABSTRACT

The disclosure relates to a method performed by a computer for identifying a space that a user of a gaze tracking system is viewing, the method comprising obtaining gaze tracking sensor data, generating gaze data comprising a probability distribution using the sensor data by processing the sensor data by a trained model and identifying a space that the user is viewing using the probability distribution.

### CROSS REFERENCE TO RELATED APPLICATIONS

This application claims priority to Swedish Application No. 1950727-6, filed Jun. 14, 2019; the content of which are hereby incorporated by reference.

### TECHNICAL FIELD

The present application relates to user gaze detection systems and methods. In particular user gaze detection systems configured to receive user input. In an example, such systems and methods use trained models, such as neural networks, to identify a space that a user of a gaze tracking system is viewing.

### BACKGROUND

Interaction with computing devices is a fundamental action in today's world. Computing devices, such as personal computers, tablets, smartphones, are found throughout daily life. The systems and methods for interacting with such devices define how they are used and what they are used for.

Advances in eye/gaze tracking technology have made it possible to interact with a computer/computing device using a person's gaze information. E.g. the location on a display that the user is gazing at may be used as input to the computing device. This input can be used for interaction solely, or in combination with a contact-based interaction technique (e.g., using a user input device, such as a keyboard, a mouse, a touch screen, or another input/output interface).

The accuracy of a gaze tracking system is highly dependent on the individual using the system. A system may perform extraordinary well on most users, but for some individuals it may have a hard time even getting the gaze roughly right.

Attempts have been made to expand existing gaze tracking techniques to rely on trained models, e.g. neural networks, to perform gaze tracking. However, the accuracy of the gaze tracking varies, and may perform poorly for some specific individuals. The trained model may have a hard time tracking the gaze, and may not even get the gaze estimate roughly right.

A drawback with such conventional gaze tracking systems, is that a gaze signal is always outputted, no matter how poor it is. In other words, a gaze signal or estimate will be provided even when the quality or confidence level of the gaze signal or estimate is so low that it is close to a uniformly random estimate of the gaze. A computer/computing device using the gaze signal or estimate has no means of knowing that the provided gaze signal or estimate is not to be trusted, and may result in unwanted results.

Thus, there is a need for an improved method for performing gaze tracking.

### OBJECTS OF THE INVENTION

An objective of embodiments of the present invention is to provide a solution which mitigates or solves the drawbacks described above.

### SUMMARY OF THE INVENTION

The above objective is achieved by the subject matter described herein. Further advantageous implementation forms of the invention are described herein.

According to a first aspect of the invention the objects of the invention is achieved by a method performed by a computer for identifying a space that a user of a gaze tracking system is viewing, the method comprising obtaining gaze tracking sensor data, generating gaze data comprising a probability distribution using the sensor data by processing the sensor data by a trained model, identifying a space that the user is viewing using the probability distribution.

At least one advantage of of the first aspect of the invention is that reliability of user input can be improved by providing gaze tracking applications with a gaze estimate and an associated confidence level.

In a first embodiment of the first aspect, the space comprises a region, wherein the probability distribution is indicative of a plurality of regions, each region having related confidence data indicative of a confidence level that the user is viewing the region.

In a second embodiment according to the first embodiment, the plurality of regions forms a grid representing a display the user is viewing.

In a third embodiment according to the first or second embodiment, identifying the space the user is viewing comprises selecting a region, from the plurality of regions, having a highest confidence level.

In a fourth embodiment according to the second or third embodiment, the method further comprises determining a gaze point using the selected region.

In a fifth embodiment according to the first embodiment, each region of the plurality of regions is arranged spatially separate and representing an object that the user is potentially viewing, wherein said object is a real object and/or a virtual object.

In a sixth embodiment according to the fifth embodiment, identifying the region the user is viewing comprises selecting a region of the plurality of regions having a highest confidence level.

In a seventh embodiment according to the sixth embodiment, the method further comprises selecting an object using the selected region.

In an eighth embodiment according to the seventh embodiment, the method further comprises determining a gaze point using the selected region and/or the selected object.

In a ninth embodiment according to any of the first to the eighth embodiment, the objects are displays and/or input devices, such as mouse or keyboard.

In a tenth embodiment according to any of the first to eighth embodiment, the objects are different interaction objects comprised in a car, such as mirrors, center console and dashboard.

In an eleventh embodiment according to any of the preceding embodiments, the space comprises a gaze point, wherein the probability distribution is indicative of a plurality of gaze points, each gaze point having related confidence data indicative of a confidence level that the user is viewing the gaze point.

In a twelfth embodiment according to the eleventh embodiment, identifying the space the user is viewing comprises selecting a gaze point of the plurality of gaze points having a highest confidence level.

In an thirteenth embodiment according to any of the preceding embodiments, the space comprises a three-dimensional gaze ray defined by a gaze origin and a gaze direction, wherein the probability distribution is indicative of a plurality of gaze rays, each gaze ray having related confidence data indicative of a confidence level that the direction the user is viewing coincides with the gaze direction of a respective gaze ray.

In an fourteenth embodiment according to the thirteenth embodiment, identifying the space the user is viewing comprises selecting a gaze ray of the plurality of gaze rays having a highest confidence level.

In a fifteenth embodiment according to the fourteenth embodiment, the method further comprises determining a gaze point using the selected gaze ray and a surface.

In a fifteenth embodiment according to any of the preceding embodiments, the trained model comprises any one of a neural network, boosting based regressor, a support vector machine, a linear regressor and/or random forest.

In an sixteenth embodiment according to any of the preceding embodiments, the probability distribution comprised by the trained model is selected from any one of a gaussian distribution, a mixture of gaussian distributions, a von Mises distribution, a histogram and/or an array of confidence values.

According to a second aspect of the invention the objects of the invention is achieved by a computer, the computer comprising:

an interface to one or more image sensors, a processor; and

a memory, said memory containing instructions executable by said processor, whereby said computer is operative to perform the method according to first aspect.

According to a third aspect of the invention the objects of the invention is achieved by a computer program comprising computer-executable instructions for causing a computer, when the computer-executable instructions are executed on processing circuitry comprised in the computer, to perform any of the method steps according to the first aspect.

According to a fourth aspect of the invention the objects of the invention is achieved by a computer program product comprising a computer-readable storage medium, the computer-readable storage medium having the computer program according to the third aspect embodied therein.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a cross-sectional view of an eye.

FIG. 2 shows a gaze tracking system according to one or more embodiments of the present disclosure.

FIG. 3 shows a flowchart of a method according to one or more embodiments of the present disclosure.

FIG. 4 illustrates an embodiment where the identified space comprises plurality of regions according to one or more embodiments of the present disclosure.

FIG. 5A-B illustrates spaces as spatially separate objects according to one or more embodiments of the present disclosure.

FIG. 6 illustrates spaces as gaze points according to one or more embodiments of the present disclosure.

FIG. 7 illustrates identification of a space as a gaze ray according to one or more embodiments.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

An “or” in this description and the corresponding claims is to be understood as a mathematical OR which covers “and” and “or”, and is not to be understand as an XOR (exclusive OR). The indefinite article “a” in this disclosure and claims is not limited to “one” and can also be understood as “one or more”, i.e., plural.

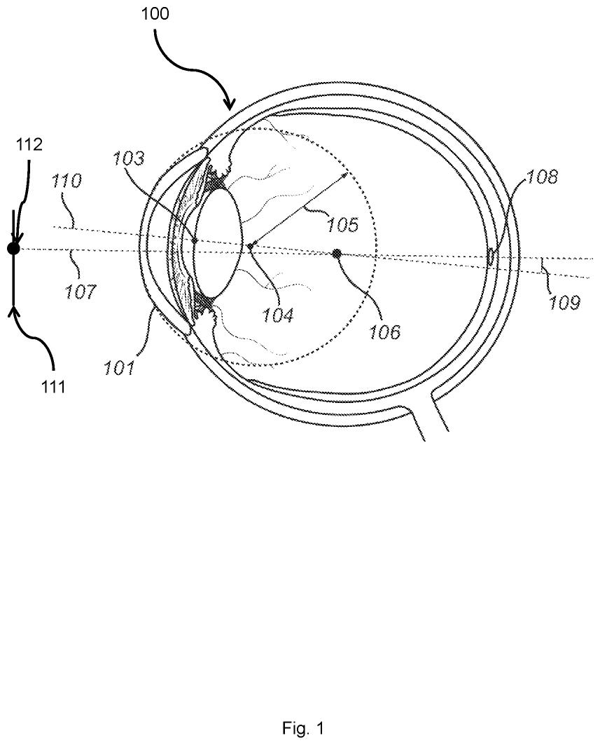

FIG. 1 shows a cross-sectional view of an eye 100. The eye 100 has a cornea 101 and a pupil 102 with a pupil center 103. The cornea 101 is curved and has a center of curvature 104 which is referred as the center 104 of corneal curvature, or simply the cornea center 104. The cornea 101 has a radius of curvature referred to as the radius 105 of the cornea 101, or simply the cornea radius 105. The eye 100 has a center 106 which may also be referred to as the center 106 of the eye ball, or simply the eye ball center 106. The visual axis 107 of the eye 100 passes through the center 106 of the eye 100 to the fovea 108 of the eye 100. The optical axis 110 of the eye 100 passes through the pupil center 103 and the center 106 of the eye 100. The visual axis 107 forms an angle 109 relative to the optical axis 110. The deviation or offset between the visual axis 107 and the optical axis 110 is often referred to as the fovea offset 109.

In the example shown in FIG. 1, the eye 100 is looking towards a target 111. The visual axis 107 can be seen as forming a three-dimensional vector or gaze ray having a gaze origin at the center 106 of the eye and a gaze direction aligning with the visual axis 107. A gaze point 112 is formed where the gaze ray intersects with a two-dimensional plane formed by the target 111.

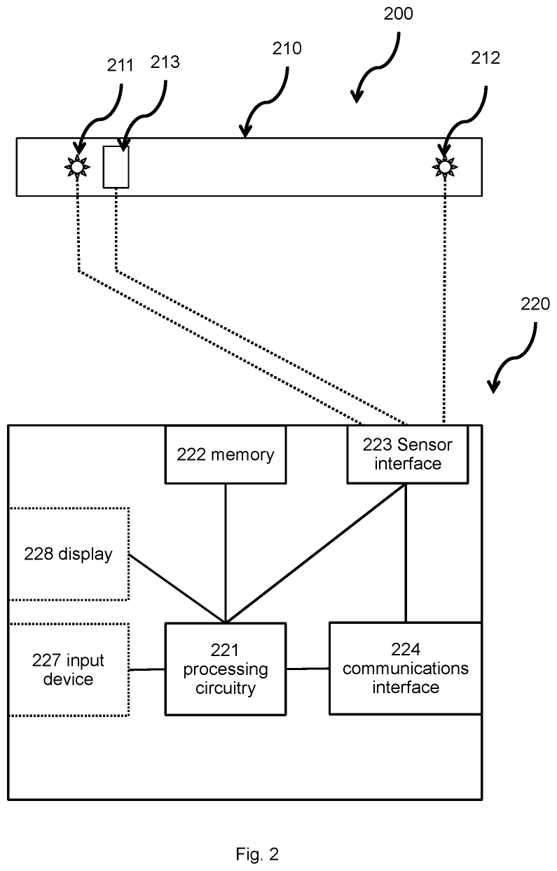

FIG. 2 shows an eye tracking system 200 (which may also be referred to as a gaze tracking system), according to one or more embodiments of the present disclosure. The system 200 may comprise at least one illuminator 211 and 212 for illuminating the eyes of a user, and at least one image sensor 213 for capturing images of the eyes of the user. The at least one illuminator 211, 212 and the image sensor 213 may e.g. be arranged as separate units, integrated into an eye tracking unit 210 or be comprised in a computer 220.

The illuminators 211 and 212 may for example, be light emitting diodes emitting light in the infrared frequency band, or in the near infrared frequency band. The image sensor 213 may for example be a camera, such as a complementary metal oxide semiconductor (CMOS) camera or a charged coupled device (CCD) camera. The camera is not limited to be an IR camera or a depth camera or a light-field camera. The shutter mechanism of the image sensor can either be a rolling shutter or a global shutter.

The first illuminator 211 may be arranged coaxially with (or close to) the image sensor 213 so that the image sensor 213 may capture bright pupil images of the user's eyes. Due to the coaxial arrangement of the first illuminator 211 and the image sensor 213, light reflected from the retina of an eye returns back out through the pupil towards the image sensor 213, so that the pupil appears brighter than the iris surrounding it in images where the first illuminator 211 illuminates the eye. The second illuminator 212 is arranged non-coaxially with (or further away from) the image sensor 213 for capturing dark pupil images. Due to the non-coaxial arrangement of the second illuminator 212 and the image sensor 213, light reflected from the retina of an eye does not reach the image sensor 213 and the pupil appears darker than the iris surrounding it in images where the second illuminator 212 illuminates the eye. The illuminators 211 and 212 may for example, take turns to illuminate the eye, so that every first image is a bright pupil image, and every second image is a dark pupil image.

The eye tracking system 200 also comprises processing circuitry 221 (for example including one or more processors) for processing the images captured by the image sensor 213. The circuitry 221 may for example, be connected/communicatively coupled to the image sensor 213 and the illuminators 211 and 212 via a wired or a wireless connection. In another example, the processing circuitry 221 is in the form of one or more processors and may be provided in one or more stacked layers below the light sensitive surface of the image sensor 213.

FIG. 2 further shows a computer 220 according to an embodiment of the present disclosure. The computer 220 may be in the form of a selection of any of one or more Electronic Control Units, a server, an on-board computer, an digital information display, a stationary computing device, a laptop computer, a tablet computer, a handheld computer, a wrist-worn computer, a smart watch, a PDA, a Smartphone, a smart TV, a telephone, a media player, a game console, a vehicle mounted computer system or a navigation device. The computer 220 may comprise the processing circuitry 221.

The computer 220 may further comprise a communications interface 224, e.g. a wireless transceiver 224 and/or a wired/wireless communications network adapter, which is configured to send and/or receive data values or parameters as a signal to or from the processing circuitry 221 to or from other computers and/or to or from other communication network nodes or units, e.g. to/from the at least one image sensor 213 and/or to/from a server. In an embodiment, the communications interface 224 communicates directly between control units, sensors and other communication network nodes or via a communications network. The communications interface 224, such as a transceiver, may be configured for wired and/or wireless communication. In embodiments, the communications interface 224 communicates using wired and/or wireless communication techniques. The wired or wireless communication techniques may comprise any of a CAN bus, Bluetooth, WiFi, GSM, UMTS, LTE or LTE advanced communications network or any other wired or wireless communication network known in the art.

In one or more embodiments, the computer 220 may further comprise a dedicated sensor interface 223, e.g. a wireless transceiver and/or a wired/wireless communications network adapter, which is configured to send and/or receive data values or parameters as a signal to or from the processing circuitry 221, e.g. gaze signals to/from the at least one image sensor 213.

Further, the communications interface 224 may further comprise at least one optional antenna (not shown in figure). The antenna may be coupled to the communications interface 224 and is configured to transmit and/or emit and/or receive a wireless signals in a wireless communication system, e.g. send/receive control signals to/from the one or more sensors or any other control unit or sensor. In embodiments including the sensor interface 223, at least one optional antenna (not shown in figure) may be coupled to the sensor interface 223 configured to transmit and/or emit and/or receive a wireless signals in a wireless communication system.

In one example, the processing circuitry 221 may be any of a selection of processor and/or a central processing unit and/or processor modules and/or multiple processors configured to cooperate with each-other. Further, the computer 220 may further comprise a memory 222.

In one example, the one or more memory 222 may comprise a selection of a hard RAM, disk drive, a floppy disk drive, a magnetic tape drive, an optical disk drive, a CD or DVD drive (R or RW), or other removable or fixed media drive. The memory 222 may contain instructions executable by the processing circuitry to perform any of the methods and/or method steps described herein.

In one or more embodiments the computer 220 may further comprise an input device 227, configured to receive input or indications from a user and send a user-input signal indicative of the user input or indications to the processing circuitry 221.

In one or more embodiments the computer 220 may further comprise a display 228 configured to receive a display signal indicative of rendered objects, such as text or graphical user input objects, from the processing circuitry 221 and to display the received signal as objects, such as text or graphical user input objects.

In one embodiment the display 228 is integrated with the user input device 227 and is configured to receive a display signal indicative of rendered objects, such as text or graphical user input objects, from the processing circuitry 221 and to display the received signal as objects, such as text or graphical user input objects, and/or configured to receive input or indications from a user and send a user-input signal indicative of the user input or indications to the processing circuitry 221.

In embodiments, the processing circuitry 221 is communicatively coupled to the memory 222 and/or the sensor interface 223 and/or the communications interface 224 and/or the input device 227 and/or the display 228 and/or the at least one image sensor 213. The computer 220 may be configured to receive the sensor data directly from the at least one image sensor 213 or via the wired and/or wireless communications network.

In a further embodiment, the computer 220 may further comprise and/or be coupled to one or more additional sensors (not shown) configured to receive and/or obtain and/or measure physical properties pertaining to the user or environment of the user and send one or more sensor signals indicative of the physical properties to the processing circuitry 221, e.g. sensor data indicative of ambient light.

The computer 760, described herein may comprise all or a selection of the features described in relation to FIG. 2.

The server 770, described herein may comprise all or a selection of the features described in relation to FIG. 2.

In one embodiment, a computer 220 is provided. The computer 220 comprising an interface 223, 224 to one or more image sensors 213, a processor 221; and a memory 222, said memory 222 containing instructions executable by said processor 221, whereby said computer is operative to perform any method steps of the method described herein.

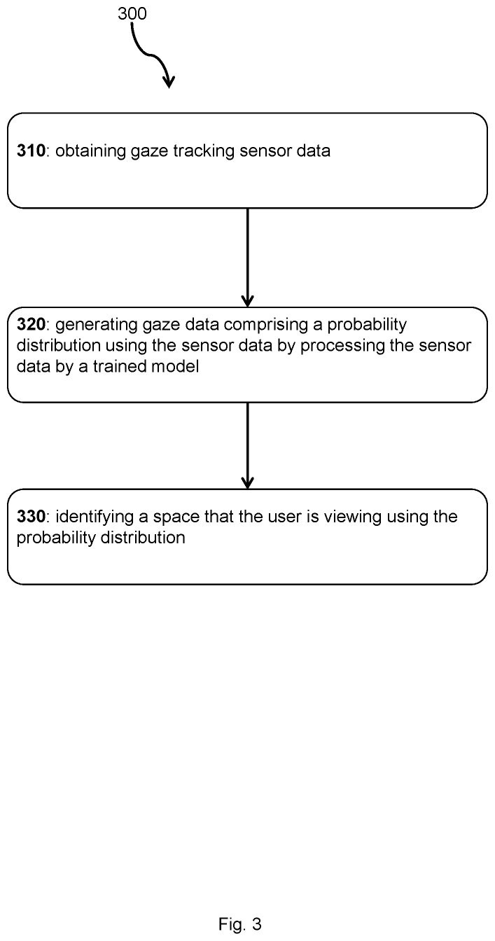

FIG. 3 shows a flowchart of a method 300 according to one or more embodiments of the present disclosure. The method is performed by a computer configured to identify a space that a user of a gaze tracking system is viewing, the method comprising:

Step 310: obtaining gaze tracking sensor data.

The image or gaze tracking sensor data may be received comprised in signals or gaze signals, e.g. wireless signals, from the at least one image sensor 213, from the eye tracking unit 210.

Additionally or alternatively, the gaze tracking sensor data may be received from another node or communications node, e.g. from the computer 220. Additionally or alternatively, the gaze tracking sensor data may be retrieved from memory.

Step 320: generating gaze data comprising a probability distribution using the sensor data by processing the sensor data by a trained model.

In one embodiment, the trained model comprises a selection of any of a neural network (such as CNN), boosting based regressor (such as a gradient boosted regressor; gentle boost; adaptive boost), a support vector machine, a linear regressor and/or random forest.

In one embodiment, the probability distribution comprises a selection of any of a gaussian distribution, a mixture of gaussian distributions, a von Mises distribution, a histogram and/or an array of confidence values.

In one example, the wired/wireless signals from the at least one image sensor 213 are received by the computer 220 and the gaze tracking sensor data is extracted from the signals, e.g. by demodulating/decoding an image depicting a user's eyes from the signals. The gaze tracking sensor data is then fed to and processed by the trained model, e.g. a convolutional neural network. The trained model then outputs gaze data, e.g. two-dimensional isotropic Gaussian probability distribution of gaze positions.

This is in contrast to conventional systems that typically provides a single point. Practically this means that, instead of letting the trained model output a 2-dimensional vector for each gaze point (x,y), it outputs a two-dimensional mean vector (x̅, y̅) and a one-dimensional standard-deviation vector (σ) representing the confidence, e.g. a variance or standard distribution, of the gaze point being a gaze point that the user is viewing. The two-dimensional mean vector is then squared and multiplied with an identity matrix gives the covariance matrix.

The probability distribution over y can then be described according to the relation:

p(y|x,θ)= [symbol] (y|μ_{θ}(x),σ_{θ}(x))

where x is the input, y are the labels (stimulus points) of the trained model and theta T is the trained model parameters. By imposing a prior on the model parameters T, the Maximum A-Posteriori, MAP, loss function can be formulated as

[symbol]

(x,y)=−λp(y|x,θ)p(θ),

where λ is an arbitrary scale parameter. Minimizing this loss function is equivalent to maximizing the mode of the posterior distribution over the model parameters. When deploying the network one can use the outputted mean vector as the gaze signal, and the standard deviation as a measure of confidence.

Step 330: identifying a space that the user is viewing using the probability distribution. In one example, the gaze data comprises a Gaussian probability distribution of gaze positions, where each gaze position or gaze position comprises a mean position vector (x̅,y̅)ᵢ and a standard deviation vector (σ)ᵢ, where i is the index of the respective gaze position. In the case that the probability distribution comprises a single gaze position, identifying the space may comprise identifying the mean position vector (x̅,y̅)ᵢ as the space if the standard deviation vector (σᵢ) is below a threshold or identifying the most recently identified gaze position as the space if the standard deviation vector (σᵢ) is equal to or below the threshold. In the case that the probability distribution comprises a plurality of gaze positions, identifying the space may comprise identifying the mean position vector (x̅,y̅)ⱼ as the space if the standard deviation vector (σⱼ) is the lowest of the plurality of gaze positions.

In some embodiments, the space is represented as a region. A typical example is a scenario when a user is viewing a screen, and the screen is at least partially split into a plurality of adjacent non-overlapping regions.

Additionally or alternatively, the space of the method 300 comprises a region, the probability distribution is then indicative of a plurality of regions, each region having related confidence data indicative of a confidence level that the user is viewing the region.

The trained model may be obtained or trained by providing training or calibration data, typically comprises 2D images and corresponding verified gaze data.

In one embodiment, a selection of the method steps described above is performed by a computer, such as a laptop.

In one embodiment, a selection of the method steps described above is performed by a server, such as a cloud server.

In one embodiment, a selection of the method steps described above is performed by a computer 760, such as a laptop, and the remaining steps are performed by the server 770. Data, such as gaze tracking sensor data or gaze data may be exchanged over a communications network 780.

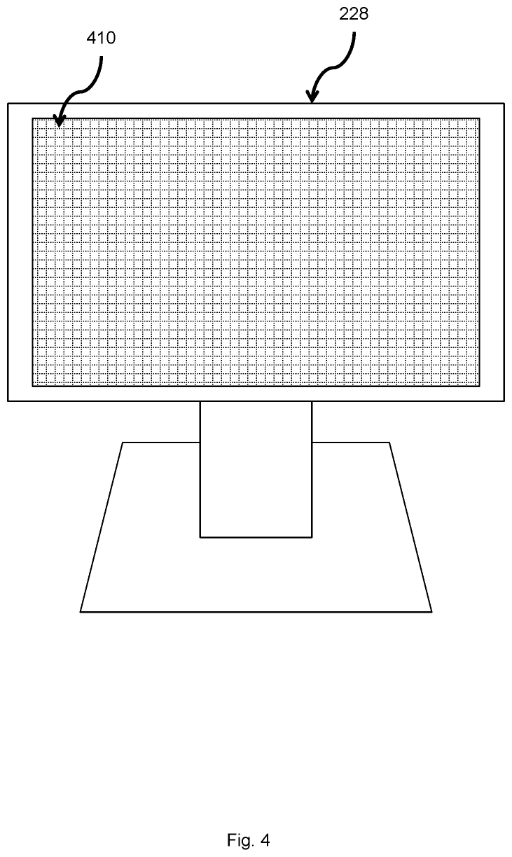

FIG. 4 illustrates an embodiment where the identified space comprises plurality of regions according to one or more embodiments of the present disclosure. FIG. 4 shows an example of a display 228 split or divided into one or more regions 410 (shown as dashed squares in the figure), whereof a user is viewing at least one of the regions. The regions may be partially or completely overlapped with the displayed area of the display 228.

In one embodiment, the space comprises a region. The probability distribution of the gaze data is indicative of a plurality of regions 410, each region having related confidence data indicative of a confidence level that the user is viewing the region.

Additionally or alternatively, the plurality of regions 410 forms a grid representing a display 228 the user is viewing.

Additionally or alternatively, the step 330 of identifying the space the user is viewing comprises selecting a region, from the plurality of regions 410, having a highest confidence level.

In one example, the wired/wireless signals, e.g. sensor signals, from the at least one image sensor 213 are received by the computer 220 and the gaze tracking sensor data is extracted from the signals, e.g. by demodulating/decoding/processing an image depicting a user's eyes from the signals. The gaze tracking sensor data is then fed to and processed by the trained model, e.g. a convolutional neural network. The trained model then outputs gaze data, e.g. a two-dimensional isotropic Gaussian probability distribution of regions in a similar fashion as described in the example above, in relation to step 320, for gaze positions. In other words, a probability distribution is provided comprising associated or aggregated data identifying a region and the confidence level that a user is viewing that region.

Additionally or alternatively, the method further comprises determining a gaze point using the selected region. The gaze point may e.g. be determined as the geometric center of the region or center of mass of the region.

In some embodiments, the plurality of regions are not adjacent but rather arranged spatially separate. This may e.g. be the case in some augmented reality applications or in vehicle related applications of the method described herein.

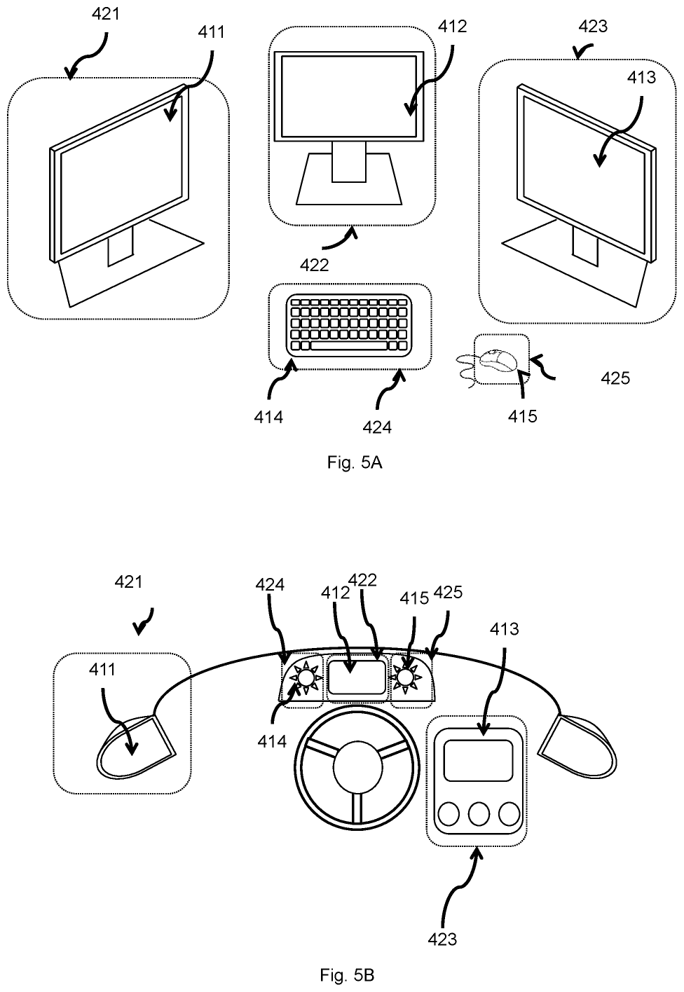

FIG. 5A illustrates spaces as spatially separate objects according to one or more embodiments of the present disclosure. FIG. 5A shows a plurality of regions 421-425 arranged spatially separate and each region representing an object that the user is potentially viewing. The objects in this example are three computer displays 411-413, a keyboard 414 and a mouse 415. The regions 421-425 typically encloses each object 411-415.

Additionally or alternatively, each region of the plurality of regions 421-425 may be arranged spatially separate and represent an object 411-415 that the user is potentially viewing. The object 411-415 may be a real object and/or a virtual object or a mixture of real and virtual objects.

Additionally or alternatively, the step 330 of identifying the region the user is viewing may comprise selecting a region of the plurality of regions 421-425 having a highest confidence level.

Additionally or alternatively, the method may further comprise identifying or selecting an object using the selected region. E.g. by selecting the object enclosed by the selected region.

Additionally or alternatively, the method further comprises determining a gaze point or gaze position using the selected region and/or the selected object. The gaze point or gaze position may be e.g. be determined as the geometric center of the selected region and/or the selected object or center of mass of the selected region and/or the selected object.

Additionally or alternatively, the objects may be displays and/or input devices, such as mouse or keyboard.

FIG. 5B illustrates spaces as spatially separate interaction objects according to one or more embodiments of the present disclosure. FIG. 5B shows a plurality of regions 421-425 arranged spatially separate and each region representing an object 411-415 that the user is potentially viewing.

Additionally or alternatively, the objects are different interaction objects comprised in a car, such as mirrors 411, center console 413 and dashboard with dials 414, 415 and information field 412.

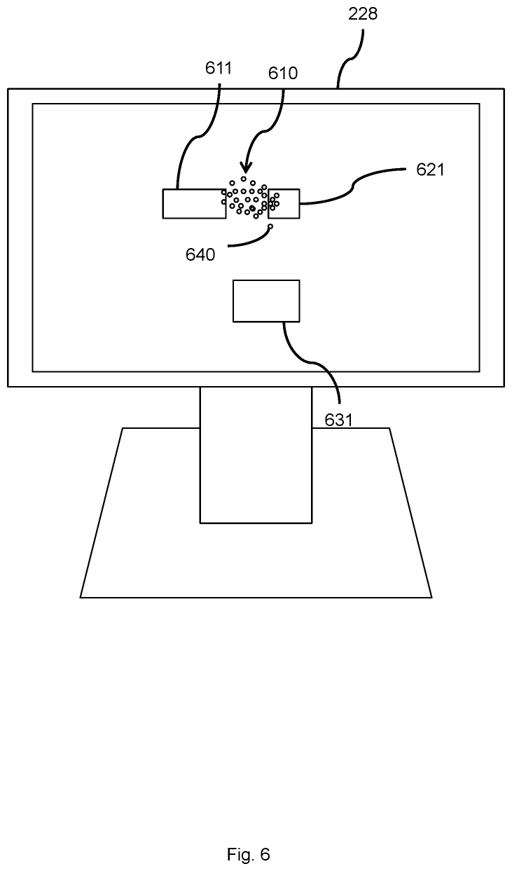

FIG. 6 illustrates spaces as gaze points according to one or more embodiments of the present disclosure. FIG. 6 illustrates identification of a space as a gaze point 640 according to one or more embodiments. The method described herein relates to analysis of a gaze point 640 of a user interacting with a computer using gaze tracking functionality. Using the gaze point 640, enables an object 611 of a plurality of visualized objects 611, 621, 631 at which a user is watching can be determined or selected or identified by a gaze tracking application. The term visualized object may refer to any visualized object or area in visualization that a user of the system may direct its gaze at. In the present disclosure, the generated gaze data comprises a probability distribution indicative of a plurality of gaze points, each gaze point having related confidence data indicative of a confidence level that the user is viewing the gaze point. In one example, the gaze points of the probability distribution have the shape of a “gaze point cloud” 610, as shown in FIG. 6.

FIG. 6 further shows a display 228 comprising or visualizing three visualized objects 611, 621, 631 and a probability distribution, wherein the probability distribution comprises a number of gaze points/positions shown on the display 228 having different confidence levels, illustrated as points 610 in the distribution in FIG. 6.

In one embodiment, the identified space comprises or is a gaze point 640, wherein the probability distribution is indicative of a plurality of gaze points 610, each gaze point having related confidence data indicative of a confidence level that the user is viewing the gaze point.

Additionally or alternatively, identifying the space the user is viewing comprises selecting a gaze point 640 of the plurality of gaze points 610 having a highest confidence level.

In one example, the wired/wireless signals, e.g. sensor signals, from the at least one image sensor 213 are received by the computer 220 and the gaze tracking sensor data is extracted from the signals, e.g. by demodulating/decoding/processing an image depicting a user's eyes from the signals. The gaze tracking sensor data is then fed to and processed by the trained model, e.g. a convolutional neural network. The trained model then outputs gaze data, e.g. a two-dimensional isotropic Gaussian probability distribution of gaze points in a similar fashion as described in the example above, in relation to step 320. In other words, a probability distribution is provided comprising associated or aggregated data identifying a gaze point and the confidence level that a user is viewing that gaze point.

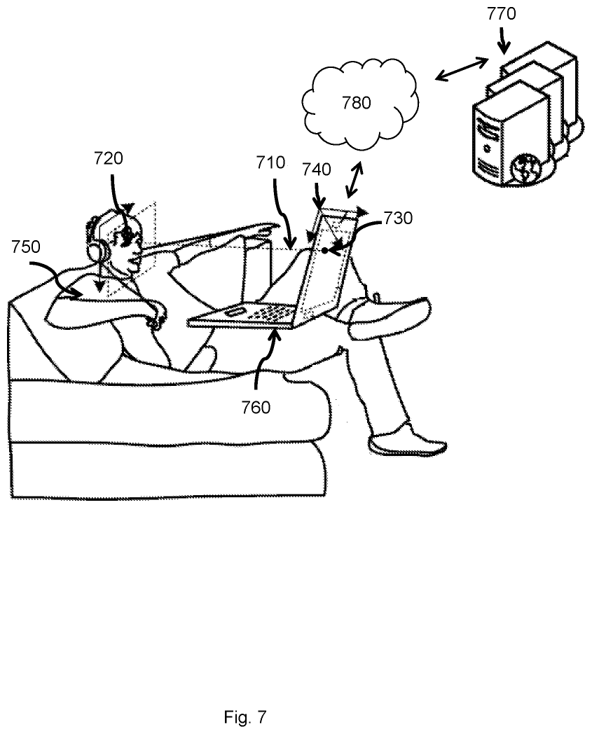

FIG. 7 illustrates identification of a space as a gaze ray 710 according to one or more embodiments. FIG. 7 illustrates an example computing environment identifying a gaze ray 710 based on a trained model or deep learning system, according to an embodiment.

Typically, 2D gaze data refers to an X, Y gaze position 730 on a 2D plane 740, e.g. a 2D plane formed by a computer screen viewed by the user 750. In comparison, 3D gaze data refers to not only the X, Y gaze position, but also the Z gaze position. In an example, the gaze ray 710 can be characterized by gaze origin 720 or an eye position in 3D space as the origin and a direction of the 3D gaze from the origin.

As illustrated in FIG. 7, a user 750 operates a computer or computing device 760 that tracks the gaze ray 710 of the user 750. To do so, the computing device 760 is, in one example, in communication with a server 770 that hosts a trained model/machine learning model/deep learning model system. The computing device 760 sends, to the server 770 over a communications network 780, gaze tracking sensor data in the form of a 2D image depicting the user eyes while the user 750 is gazing at the screen of the computer or computing device 760. The server 770 inputs this 2D image to the trained model that, in response, generates a probability distribution of gaze rays.

In one embodiment, the space of the method 300 comprises a three-dimensional gaze ray 710. The gaze ray 710 may be defined by a gaze origin 720, e.g. the center of the user's eye, and a gaze direction. The probability distribution may then be indicative of a plurality of gaze rays, each gaze ray having related confidence data indicative of a confidence level that the direction the user is viewing coincides with the gaze direction of a respective gaze ray.

Additionally or alternatively, identifying the space the user is viewing comprises selecting a gaze ray 710 of the plurality of gaze rays having a highest corresponding confidence level. In other words, gaze data comprising a probability distribution is provided comprising associated or aggregated data identifying a gaze ray and a corresponding confidence level that a user is viewing that region.

Additionally or alternatively, the method 300 further comprises determining a gaze point using the selected gaze ray and a surface, e.g. the 2D surface formed by the screen of the computer or computing device 760. Any other surface, such as a 3D surface, could be used to determine the gaze point as an intersection point of the surface and the gaze ray.

In one example, the wired/wireless signals, e.g. sensor signals, from the at least one image sensor 213 are received by the computer 220 and the gaze tracking sensor data is extracted from the signals, e.g. by demodulating/decoding/processing an image depicting a user's eyes from the signals. The gaze tracking sensor data is then fed to and processed by the trained model, e.g. a convolutional neural network. The trained model then outputs gaze data, e.g. a two-dimensional isotropic Gaussian probability distribution of gaze rays in a similar fashion as described in the example above, in relation to step 320, for gaze positions.

The server 770 may send information about the gaze data comprising the probability distribution over the communications network 780 to the computer 760. The computer or computing device 760 uses this information to execute a gaze application that provides a gaze-based computing service to the user 750, e.g. obtaining user input of selecting a visualized object.

Although FIG. 7 shows the server 770 as hosting the trained model, the embodiments of the present disclosure are not limited as such. For example, the computer 760 can download code and host an instance of the trained model. In this way, the computer 760 relies on this instance to locally generate the probability distribution and need not to send the gaze tracking sensor data/2D image to the server 770. In this example, the server 770 (or some other computer system connected thereto over the communications network 780) can train the model and provide an interface (e.g., a web interface) for downloading the code of this trained model to computing devices, thereby hosting instances of the trained model on these computing devices.

In a further example, the computer 760 includes a camera, a screen, and a 3D gaze application. The camera generates gaze tracking sensor data in the form of a 2D image that is a 2D representation of the user's face. This 2D image shows the user eyes while gazing into 3D space. A 3D coordinate system can be defined in association with the camera. For example, the camera is at the origin of this 3D coordinate system. The corresponding X and Y planes can be planes perpendicular to the camera's line-of-sight center direction/main direction. In comparison, the 2D image has a 2D plane that can be defined around a 2D coordinate system local to the 2D representation of the user's face. The camera is associated with a mapping between the 2D space and the 3D space (e.g., between the two coordinate systems formed by the camera and the 2D representation of the user's face). In an example, this mapping includes the camera's back-projection matrix and is stored locally at the computing device 760 (e.g., in storage location associated with the 3D gaze application). The computing device's 760 display may, but need not be, in the X, Y plane of the camera (if not, the relative positions between the two is determined based on the configuration of the computing device 760). The 3D gaze application can process the 2D image for inputting to the trained model (whether remote or local to the computing device 760) and can process the information about the gaze ray 710 to support stereoscopic displays (if also supported by the computing device's 760 display) and 3D applications (e.g., 3D controls and manipulations of displayed objects on the computing device's 760 display based on the tracking sensor data).

In one embodiment, a computer program is provided and comprising computer-executable instructions for causing the computer 220, when the computer-executable instructions are executed on processing circuitry comprised in the computer 220, to perform any of the method steps of the method described herein.

In one embodiment, a computer program product is provided and comprising a computer-readable storage medium, the computer-readable storage medium having the computer program above embodied therein.

In embodiments, the communications network 780 communicate using wired or wireless communication techniques that may include at least one of a Local Area Network (LAN), Metropolitan Area Network (MAN), Global System for Mobile Network (GSM), Enhanced Data GSM Environment (EDGE), Universal Mobile Telecommunications System, Long term evolution, High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, WirelessMAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

Moreover, it is realized by the skilled person that the computer 220 may comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, encoder, decoder, power supply units, power feeders, communication interfaces, communication protocols, etc. which are suitably arranged together for performing the present solution.

Especially, the processing circuitry 221 of the present disclosure may comprise one or more instances of processor and/or processing means, processor modules and multiple processors configured to cooperate with each-other, Central Processing Unit (CPU), a processing unit, a processing circuit, a processor, an Application Specific Integrated Circuit (ASIC), a microprocessor, a Field-Programmable Gate Array (FPGA) or other processing logic that may interpret and execute instructions. The expression “processing circuitry” may thus represent a processing circuitry comprising a plurality of processing circuits, such as, e.g., any, some or all of the ones mentioned above. The processing means may further perform data processing functions for inputting, outputting, and processing of data.

Finally, it should be understood that the invention is not limited to the embodiments described above, but also relates to and incorporates all embodiments within the scope of the appended independent claims.

1. A method performed by a computer for identifying a space that a user of a gaze tracking system is viewing, the method comprising:
obtaining gaze tracking sensor data,
generating gaze data comprising a probability distribution using the sensor data by processing the sensor data by a trained model,
identifying a space that the user is viewing using the probability distribution.

2. The method according to claim 1, wherein the space comprises a region, wherein the probability distribution is indicative of a plurality of regions, each region having related confidence data indicative of a confidence level that the user is viewing the region.

3. The method according to claim 2, wherein the plurality of regions forms a grid representing a display the user is viewing.

4. The method according to claim 2, wherein identifying the space the user is viewing comprises selecting a region, from the plurality of regions, having the highest confidence level.

5. The method according to claim 2, further comprising determining a gaze point using the selected region, e.g. determined as the geometric center of the region or center of mass of the region.

6. The method according to claim 2, wherein each region of the plurality of regions is arranged spatially separate and representing an object or a part of an object that the user is potentially viewing, wherein said object is a real object or a part of a real object, and/or a virtual object or a part of a virtual object.

7. The method according to claim 6, wherein identifying the region the user is viewing comprises selecting a region of the plurality of regions having the highest confidence level.

8. The method according to claim 7, further comprising selecting an object using the selected region, e.g. selecting an object enclosed by the region.

9. The method according to claim 8, further comprising determining a gaze point using the selected region and/or the selected object, e.g. determine the gaze point as the geometric center of the selected region and/or the selected object.

10. The method according to claim 2, wherein the objects are displays and/or input devices, such as mouse or keyboard.

11. The method according to claim 2, wherein the objects are different interaction objects comprised in a car, such as mirrors, center console and dashboard.

12. The method according to claim 1, wherein the space comprises a gaze point, wherein the probability distribution is indicative of a plurality of gaze points, each gaze point having related confidence data indicative of a confidence level that the user is viewing the gaze point.

13. The method according to claim 12, wherein identifying the space the user is viewing comprises selecting a gaze point of the plurality of gaze points having the highest confidence level.

14. The method according to claim 1, wherein the space comprises a three-dimensional gaze ray defined by a gaze origin and a gaze direction, wherein the probability distribution is indicative of a plurality of gaze rays, each gaze ray having related confidence data indicative of a confidence level that the direction the user is viewing coincides with the gaze direction of a respective gaze ray.

15. The method according to claim 14, wherein identifying the space the user is viewing comprises selecting a gaze ray of the plurality of gaze rays having the highest confidence level.

16. The method according to claim 15, further comprising determining a gaze point using the selected gaze ray and a surface.

17. The method according to claim 1, wherein the trained model comprises any one of a neural network, a boosting based regressor, a support vector machine, a linear regressor and/or a random forest.

18. The method according to claim 1, wherein the probability distribution comprised by the trained model is selected from any one of a gaussian distribution, a mixture of gaussian distributions, a von Mises distribution, a histogram and/or an array of confidence values.

19. A computer program comprising a non-transitory computer-readable storage medium storing containing computer-executable instructions for causing a computer, when the computer-executable instructions are executed on processing circuitry comprised in the computer, to the steps of:
obtaining gaze tracking sensor data,
generating gaze data comprising a probability distribution using the sensor data by processing the sensor data by a trained model, and
identifying a space that the user is viewing using the probability distribution.
